(19) United States
(12) Patent Application Publication
(10) Pub. No.: US 2013/0228523 A1
(43) Pub. Date: Sep. 5, 2013

(54) FLUID TREATMENT APPARATUS

(71) Applicants: Corin Main, Westhill (GB); Shejiao Han, Angus (GB); Francis Podger, Dundee (GB)

(72) Inventors: Corin Main, Westhill (GB); Shejiao Han, Angus (GB); Francis Podger, Dundee (GB)

(73) Assignee: MERPRO TORTEK LIMITED, Angus (GB)

(21) Appl. No.: 13/821,645

(22) PCT Filed: Aug. 31, 2011
(86) PCT No.: PCT/EP2011/065010

§ 371 Date: May 24, 2013

(30) Foreign Application Priority Data
Sep. 1, 2010 (EP) 10174964.6

(51) Int. Cl. C02F 1/38

(52) U.S. Cl. CPC C02F 1/38
USPC 210/703; 210/151

(57) ABSTRACT

An inlet device is provided for providing a mixture of a less dense liquid component and a more dense liquid component to a separator vessel. The inlet device comprises an annular chamber and an inlet which causes the mixture to swirl around the axis of the annular chamber. As a result, a vortex is caused in the separator vessel as the mixture enters it from the inlet device. This vortex is used to separate the more dense liquid component from the less dense liquid component, with the less dense liquid component being forced to the centre of the vortex where it is removed via an outlet which runs through the centre of the annular chamber. The inlet device also comprises a gas distributor for introducing gas bubbles into the mixture before it enters the separator vessel, thereby improving the separation of the more dense liquid component from the less dense liquid component. There is also provided a separator apparatus comprising the inlet device and the separator vessel and a method for separating a more dense liquid component from a less dense liquid component.

The present invention relates to an apparatus and method for separating a mixture comprising two fluids of different densities, such as a mixture of oil and water extracted from a well.

In the oil and gas industry, water is often present during an oil and gas extraction from a well. The water mixes with the oil and therefore cannot simply be returned to the sea or into a disposal well, for example, without first being treated to reduce the amount of oil present. Strict legislation is in place to ensure that any water being returned to the sea is sufficiently free of oil and therefore new and improved methods are constantly being sought to maximise the separation of oil and water.

An existing apparatus and method for separating a mixture of oil and water mixture is disclosed in U.S. Pat. No. 6,436,298, wherein a mixture of oil and water is caused to swirl before being introduced into a vessel, which forces dispersed oil droplets to coalesce, thereby speeding up separation. Centrifugal forces generated by the swirling mixture cause the less dense oil to migrate towards the axis of the vessel and be drawn down the centre of the vortex, while the more dense water is forced away from the axis, where it may then separate further under gravity towards the bottom of the vessel.

Improvements to such apparatus and methods are constantly being sought, both to reduce the residence time of the mixture in the apparatus and to improve the effectiveness of the separation process.

According to the present invention there is provided an inlet device for providing a mixture of a less dense liquid component and a more dense liquid component to a separator vessel, comprising: an annular chamber having a vertical axis and opening upwardly; an inlet for receiving the mixture in the bottom of the annular chamber, the inlet being configured to cause the mixture to swirl about the vertical axis as it leaves the top of the annular chamber to create a vortex in the separator vessel; a first outlet for the discharge of primarily the less dense fluid component from the separator vessel, the first outlet being axially aligned with and disposed within the annular chamber; and a gas distributor for introducing gas bubbles into the mixture before it leaves the annular chamber.

According to the present invention there is also provided an apparatus for separating a mixture of a less dense liquid component and a more dense liquid component, comprising: an inlet device as described above; and a separator vessel coupled to the inlet device.

According to the present invention there is also provided a method for separating a mixture of a less dense liquid component and a more dense liquid component, comprising the steps of: generating a swirl in the mixture in an annular chamber of an inlet device; providing gas bubbles to the mixture; introducing the mixture into a separator vessel, thereby creating a vortex within the separator vessel; removing primarily the less dense liquid from the separator vessel through an outlet disposed within and axially aligned with the annular chamber, wherein the step of providing gas bubbles to the mixture occurs prior to the step of introducing the mixture to the separator vessel.

The gas bubbles that are introduced to the mixture are, preferably, micro bubbles. For example the gas bubbles may have a diameter of 100 microns or less, or preferably around 30 microns to 50 microns. Moreover, the gas bubbles are preferably introduced to the mixture through at least a portion of one or more walls that define the separation apparatus. The first outlet for the less dense fluid may be blocked during the introduction of gas bubbles into the inlet device, if required.

In preferred embodiments, the more dense liquid component is water and the less dense liquid component is oil.

Advantageously, the introduction of gas bubbles into the mixture reduces the residence time required to allow the separation of the mixture due to the effect of the coalescence of oil droplets on the gas bubbles in the swirling mixture.

In addition, existing separation apparatus can also be modified to provide a separation apparatus according to the present invention on a retrofit basis. For example, the inlet device of an existing separation apparatus can be replaced by an inlet device according to the present invention in order to provide improved separation capabilities.

An example of the present invention will now be described, with reference to the accompanying figures, in which:

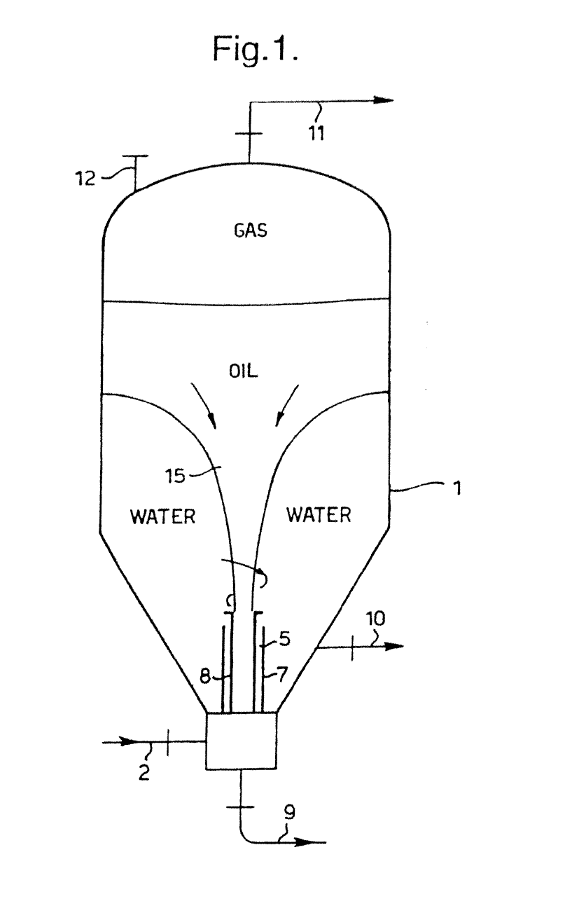

FIG. 1 shows a separation apparatus comprising a separator vessel and an existing swirl-inducing inlet device;

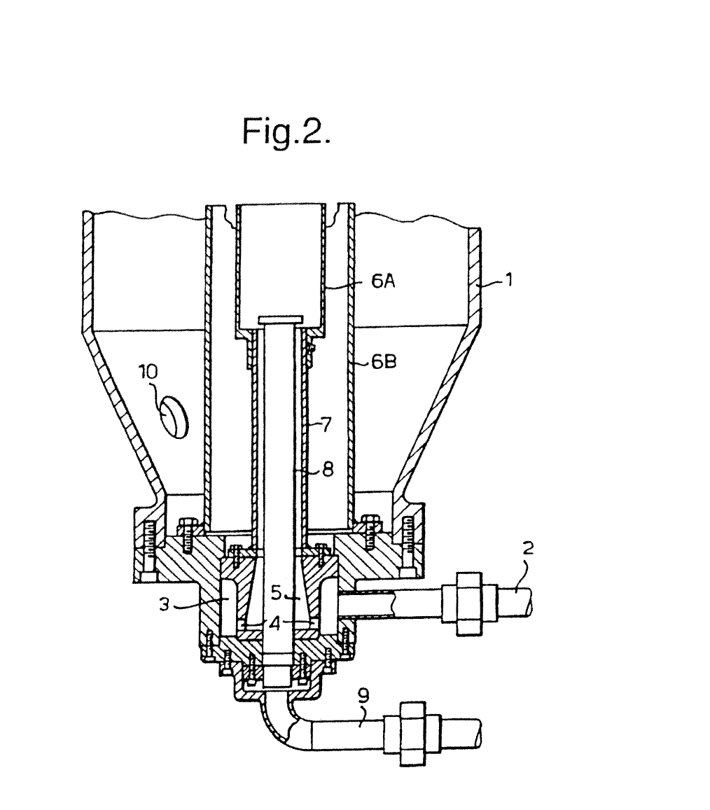

FIG. 2 is a cross section showing detail of the apparatus of FIG. 1;

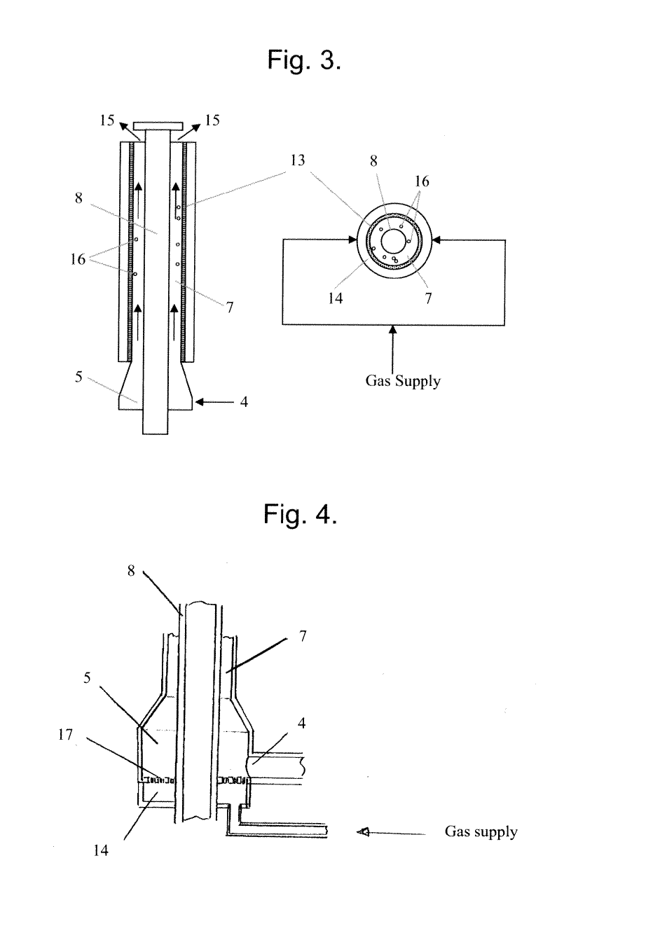

FIG. 3 shows an apparatus according to a first example of the present invention;

FIG. 4 shows an apparatus according to a second example of the present invention; and

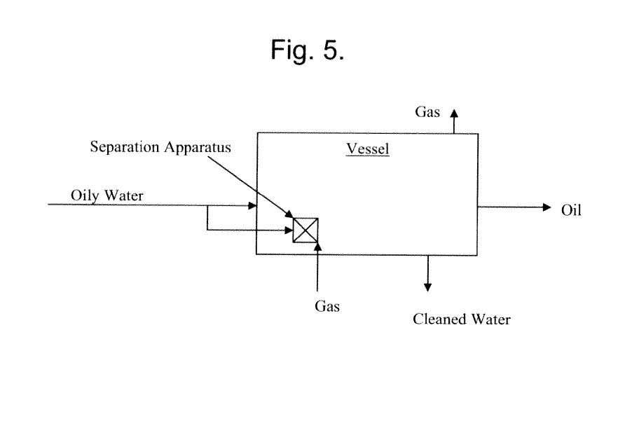

FIG. 5 is a schematic diagram of an apparatus according to the present invention installed in one or more vessels.

FIG. 1 shows a pressure vessel 1 coupled to an inlet device for separating a mixture of less dense fluid component and a more dense fluid component, i.e. two fluids having different densities, such as oil and water in this example. The pressure vessel 1 has a conical lower portion, a cylindrical mid-portion and a curved upper portion.

As can be seen from FIG. 2, the inlet device comprises an inlet chamber 5 that is fluidly connected to an annular chamber 7, which acts as a fluid supply duct, arranged to extend a substantial distance vertically into the pressure vessel 1. Arranged coaxially within the annular chamber 7 is a fluid discharge duct 8, which acts as an outlet for predominantly a less dense liquid component of the mixture provided Co the vessel 1.

In this example, the fluid discharge duct 8 which passes through the annular chamber 7 is arranged to lead to a continuous oil phase outlet 9 at the base of the pressure vessel 1. A continuous water phase outlet 10 is provided in the wall of the pressure vessel 1 towards the bottom of the pressure vessel 1 and a third outlet 11 for gas is provided at the top of the pressure vessel 1, as is a pressure controller 12.

A shield 6A, 6B may be provided either attached to the end of the annular chamber 7, as shown at 6A, or may be provided spaced from the annular chamber 7, and attached to the base of the vessel 1 as shown at 6B.

In the example shown, a fluid inlet 2 is provided at the bottom of the vessel 1, arranged to supply the mixture to an annular cavity 3 that surrounds the base of the apparatus such that mixture enters the inlet chamber 5 of the separation apparatus via inlets 4. Alternatively, a fluid inlet 2 may be arranged to connect directly to an inlet 4. In use, the mixture is supplied to the apparatus via the fluid inlet 2 at high pressure.

As the fluids pass through the inlet 4 they are caused to swirl by the positioning of the inlet 4 and/or configuration of the inlet chamber 5 in the apparatus. Centrifugal forces occur in the mixture in the apparatus as a result of the swirling motion, which is maintained as the fluids leave the annular chamber 7 and generates a vortex 15 within the vessel 1. The centrifugal forces within the swirling mixture cause drops of the less dense oil in the mixture to coalesce, and form a layer on the surface of the more dense water. Vessel pressure forces the less dense oil down through the centre of the vortex and out through the fluid discharge duct 8. The water undergoes further gravity separation in the lower part of the vessel 1 and exits the vessel through the continuous water phase outlet 10. At the same time, gas precipitates out of the oil and water and collects at the top of the vessel 1, where it can be exhausted through the gas outlet 11.

In a preferred embodiment of the present invention, there is provided a gas distributor to provide gas bubbles to the mixture before it leaves the inlet device. In particular, in preferred embodiments, the gas distributor comprises at least a portion of a wall that defines the inlet device which is arranged to be sufficiently porous to allow a pressurised gas to diffuse through it, for example by comprising a porous material, or a material that is arranged to be porous, such as ceramic. In addition, the gas distributor may comprise a gas chamber 14 is arranged to seal around the porous portion of the wall so that gas supplied to the gas chamber 14 under pressure will diffuse through the porous portion of the wall of the apparatus to form gas bubbles 16 in the swirling mixture contained within before it leaves the annular chamber 7.

The gas bubbles 16 formed are, preferably, micro bubbles. Micro-bubbles typically have a diameter of less than 100 μm, and in preferred embodiments of the present invention have a diameter of around 30 to 50 μm.

FIG. 3 shows a first example of an apparatus according to the present invention, wherein the wall 13 which defines the annular chamber 7 is arranged to be porous, as described above, and a gas chamber 14 is arranged to extend along the wall 13 and provide a seal around it.

FIG. 4 shows a second example of an apparatus according to the present invention, wherein the wall 17 that defines the base of the inlet chamber 5 is arranged to be porous, as described above, and a gas chamber 14 is provided beneath the inlet chamber 5 and arranged to provide a seal around it.

In another embodiment, at least a portion of a pipe, or similar, that comprises the fluid inlet 2, or is arranged to supply mixture to the inlet 4 of the apparatus, can be arranged to be porous and have a gas chamber arranged around it in a similar manner to the wall 13 and gas chamber 14 arrangement described in FIG. 3, to enable the introduction of gas bubbles 16 into the mixture as it enters the apparatus.

In a further embodiment, gas bubbles 16 may be introduced into the mixture before it leaves the annular chamber 7 via an inlet to the apparatus, which may be separate from, or integral to, the inlet 4 for the mixture and configured to introduce gas into the apparatus in the form of bubbles.

Furthermore, an apparatus according to the present invention may comprise a combination of any of the arrangements described herein.

Optionally, the present invention may also comprise an oscillator, or other suitable apparatus, arranged to make the pressurised gas fed into the gas chamber 14 pulsate as it diffuses through the porous portion of the wall 13, 17 to assist in the creation of gas bubbles 16 in the mixture contained within the apparatus.

By introducing gas bubbles 16 into the mixture using the inlet device, instead of using other techniques such as multiphase bubble pumps and eductors, one can avoid strong shear forces that break down large oil droplets into smaller ones and hence make separating the two fluids in the mixture difficult.

Advantageously, introducing gas bubbles into the mixture using an apparatus according to the present invention ensures that oil droplet sizes in the mixture are well preserved.

Furthermore, introducing gas bubbles 16 into the mixture before it leaves the annular chamber 7 has the effect that strong centrifugal forces in the swirling mixture within the apparatus force less dense gas bubbles to migrate towards the centre axis of the annular chamber 7, where they collide and coalesce with oil droplets to enhance separation of the mixture, rather than simply moving along the interior side of the apparatus wall. The centrifugal forces decrease after the swirling mixture leaves the annular chamber and hence so does this beneficial separation effect.

FIG. 5 is a schematic diagram of an apparatus according to the present invention installed in one or more vertical or horizontal vessels 1 having one or more chambers. A mixture of two fluids having different densities, in this example oil and water forming a mixture being known as “oily water”, is passed into one or more apparatus of the present invention, each apparatus being arranged in a substantially vertical orientation within the vessel 1 or chamber.

Gas bubbles 16 are introduced to the mixture within the apparatus, before it leaves the annular chamber 7 and enters the vessel or chamber, to assist in the separation of the mixture into its separate fluid components as it swirls. The added gas can then be vented from the vessel 1, having served its purpose.

The gas bubbles introduced by the gas distributor may be formed of any appropriate gas, but in preferred embodiments are methane gas bubbles or nitrogen gas bubbles.

The present invention is able to operate in circumstances where there is a significant proportion of both the more dense liquid in the mixture and the less dense liquid in the mixture. For example, preferred embodiments may operate in circumstances where the proportion of the mixture by volume of neither the more dense liquid or the less dense liquid is less than 5%. More preferably, the apparatus is arranged to operate is circumstances in which the proportion of the less dense material is between 5% and 40%. For example, preferred embodiments may be arranged to separate a mixture of between 5% to 40% oil and between 95% to 60% water.

Advantageously, the present invention can be adapted to replace existing separation apparatus in pressure vessels, as described with reference to FIG. 1, without having to modify the pressure vessel or its installation. It is also possible to modify an existing separation apparatus to enable gas bubbles to be introduced, as described above, to provide an apparatus according to the present invention.

1. An inlet device for providing a mixture of a less dense liquid component and a more dense liquid component to a separator vessel, comprising:
an annular chamber having a vertical axis and opening upwardly;
an inlet for receiving the mixture in the bottom of the annular chamber,
the inlet being configured to cause the mixture to swirl about the vertical axis as it leaves the top of the annular chamber to create a vortex in the separator vessel;
a first outlet for the discharge of primarily the less dense fluid component from the separator vessel, the first outlet being axially aligned with and disposed within the annular chamber; and
a gas distributor for introducing gas bubbles into the mixture before it leaves the annular chamber.

2. The device of claim 1, further comprising an inlet chamber arranged at the bottom of the annular chamber for receiving the mixture via the inlet and inducing swirl into the mixture.

3. The device of claim 1, wherein the gas distributor is arranged to introduce gas bubbles into the mixture which have a diameter of around 30 to 50 μm.

4. The device of claim 2, wherein the gas distributor is arranged to introduce gas bubbles to the mixture through a porous portion of a wall.

5. The device of claim 4, wherein the porous portion of wall comprises a porous material or a material configured to be porous.

6. The device of claim 5, wherein the material configured to be porous is ceramic.

7. The device of claim 4, wherein the gas distributor further comprises a gas chamber arranged to seal around the porous portion of wall for providing a gas under pressure to diffuse through the porous portion of wall.

8. The device of claim 4, wherein the wall at least partially defines the annular chamber.

9. The device of claim 8, wherein the wall at least partially defines a base of the inlet chamber.

10. The device of claim 4, wherein the gas distributor is arranged to cause a flow of gas to pulsate as it passes through the porous portion of wall to introduce gas bubbles in the mixture.

11. The device of claim 2, wherein the gas distributor is arranged to introduce gas bubbles into the mixture within the inlet.

12. An apparatus for separating a mixture of a less dense liquid component and a more dense liquid component, comprising:
a separator vessel; and
an inlet device coupled to the separator vessel, the inlet device comprising:
an annular chamber having a vertical axis and opening upwardly;
an inlet for receiving the mixture in the bottom of the annular chamber,
the inlet being configured to cause the mixture to swirl about the vertical axis as it leaves the top of the annular chamber to create a vortex in the separator vessel;
a first outlet for the discharge of primarily the less dense fluid component from the separator vessel, the first outlet being axially aligned with and disposed within the annular chamber; and
a gas distributor for introducing gas bubbles into the mixture before it leaves the annular chamber.

13. An apparatus according to claim 12, wherein the separator vessel comprises a second outlet arranged towards the bottom of the vessel and spaced from the first outlet for the discharge of primarily the more dense fluid component of the mixture.

14. A method for separating a mixture of a less dense liquid component and a more dense liquid component, comprising the steps of:
generating a swirl in the mixture in an annular chamber of an inlet device;
providing gas bubbles to the mixture;
introducing the mixture into a separator vessel, thereby creating a vortex within the separator vessel; and
removing primarily the less dense liquid from the separator vessel through an outlet disposed within and axially aligned with the annular chamber,
wherein the step of providing gas bubbles to the mixture occurs prior to the step of introducing the mixture to the separator vessel.

15. The method of claim 14, wherein introducing gas bubbles comprises forcing a gas through at least a portion of a wall that defines part of the inlet device, said portion of wall being porous.

16. The apparatus of claim 12, the inlet device further comprising an inlet chamber arranged at the bottom of the annular chamber for receiving the mixture via the inlet and inducing swirl into the mixture.

17. The apparatus of claim 16, wherein the gas distributor is arranged to introduce gas bubbles to the mixture through a porous portion of a wall.

18. The apparatus of claim 17, wherein the gas distributor is arranged to cause a flow of gas to pulsate as it passes through the porous portion of wall to introduce gas bubbles in the mixture

19. The apparatus of claim 16, wherein the gas distributor is arranged to introduce gas bubbles into the mixture within the inlet.
